(19) United States
(12) Patent Application Publication
(10) Pub. No.: US 2009/0278979 A1
(43) Pub. Date: Nov. 12, 2009

(54) Method, apparatus, system and software product for using flash window to hide a light-emitting diode

(76) Inventors: Judith BAYERL, Neu-Ulm (DE); Markus BAUR, Nersingen (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/152,279

(22) Filed: May 12, 2008

(51) Int. Cl. G03B 15/05; G02F 1/15; H04N 5/225

(52) U.S. Cl. 348/371; 359/275; 348/E05.029

(57) ABSTRACT

A method, apparatus, and software are devised for providing an enable signal indicative that an illuminating element of an apparatus will be illuminated. In response to that enable signal, a light transmission property of an electrically switchable material is increased, the electrically switchable material being located at an exterior of the apparatus. Also, the illuminating element is activated, so that it shines through the electrically switchable material, at least after the light transmission property of the electrically switchable material has been increased.

### FIELD OF THE INVENTION

The invention relates to telecommunications devices, and more particularly to wireless telecommunications devices having camera capability.

### BACKGROUND OF THE INVENTION

A typical wireless phone can be carried by a user in a portable manner, and it is well know for such mobile devices to have camera capability. For this reason, it is also well known to equip a wireless phone with a flash, such as a light-emitting diode (LED) flash that enables photographic capability even when the environment would not otherwise be sufficiently well-lit. The flash may also be adapted to provide continuous light, either for using the mobile device as a video camera, or instead to use the mobile device as a flashlight (sometimes called a “torch light”).

In handheld mobile devices, such as a cell phone or personal digital assistant (PDA), a camera with flash support is becoming more and more common. The flash gives the user the possibility to take pictures in unlit or poorly lit environments. Due to their technology, white flash LEDs have a yellowish appearance when not in use. In addition, the flash lens structure that is used to enhance optical performance of the flash may also be visible to the user, and visible to other people in the user's vicinity as well. This yellowish appearance, with or without the visible lens structure (e.g. Fresnel lens), often does not match with the design of the device. Additionally, the yellowish appearance and/or the lens structure can make the flash device noticeable as such, against the wishes of the user who may prefer that the flash device not be seen when it is not in use.

A key problem with prior art LED flash devices is that when they are not in use (i.e. not being used for photographic purposes or as a flashlight), they are nevertheless very visible to a person looking at the mobile device. When a white flash LED is not in use, its typical distinctive yellowish appearance can be readily seen not just by the user of the mobile phone, but by other nearby people as well. Such unnecessary visibility of an LED flash device has many potential disadvantages. For example, the visibility of the LED flash device can give people (other than the user) the impression that the user may soon attempt to take a photograph, even though the user may not intend to take a photograph, or even though the user may not intend for other people to know that the user has photographic (or flashlight) capability. Also, the user may not want other people to request that the user take a picture, or may not want potential thieves to easily see that his wireless phone is equipped with valuable flash capability. Furthermore, the user may prefer not to see features of his mobile device (such as an LED flash) when the user is not preparing to use those features, because such a feature may be distracting and irrelevant to what the user is doing. When a white flash LED is not in use, its yellowish appearance may be unappealing to some people, but the appearance is only one of many problems that are caused by allowing the LED flash device to be visible when not in use. Such visibility may be unnecessary not only when the user is not using any photographic capability, but also when the ambient environment is well-lit.

There is presently no way to eliminate or reduce the unnecessary visibility of an LED flash device, without also unnecessarily increasing protection for the LED flash device. It is known to equip a mobile device with a moveable cover for a flash device, but such a cover does more than necessary: it provides protection to the flash device, in addition to eliminating visibility of the flash device. Additionally, such a cover typically requires moving parts, and would only be reliable if considerable time and money are used to manufacture and install the cover in the mobile device.

It is known to cover a flash device in order to provide protection for the flash device. See, for example, Okuda (U.S. Pat. No. 7,057,660) which discloses a sliding flash cover. Another way to provide protection for a flash device is to have a pop-up flash instead of a fixed flash cover, and the popup flash may pop up manually, or pop up when insufficient illumination is detected. However, both a pop-up flash and a fixed flash cover do more than necessary, by providing increased protection when all that may be needed is reduced visibility.

It is known to create a “smart glass” window using switchable transmissivity, such as for privacy purposes. However, that type of window is typically large, and has not been adapted for handheld mobile devices. Smart glass (also called switchable glass, smart windows, or switchable windows) refers to electrically switchable glass or glazing which changes light transmission properties when voltage is applied; with the press of a button. Smart glass technologies include electrochromic devices, suspended particle devices, and liquid crystal devices. It is known that the use of smart glass can save costs for heating, air-conditioning, and lighting, as well as avoid the cost of installing and maintaining motorized light screens or blinds and curtains. Passengers aboard aircraft are now able to darken or lighten their windows at the touch of a button for more comfortable travel, instead of using a mechanical window cover.

Electrochromic devices change light transmission properties in response to voltage. In electrochromic windows, the electrochromic material changes its opacity between a colored, translucent state (often the color blue) and a transparent state. A burst of electricity is required for changing its opacity, but once the change has been effectuated, no electricity is needed for maintaining the particular shade which has been reached. Darkening typically occurs from the edges, moving inward, and is a slow process, ranging from many seconds to several minutes depending on window size. Recent advances in electrochromic materials pertaining to transition-metal hydride electrochromics have led to the development of reflective hydrides, which switch states between transparent and mirror-like (transition-metal hydrides are chemical compounds containing a transition metal bonded to hydrogen).

In suspended particle devices (SPDs), a film of rod-like particles in a fluid is placed between two glass or plastic layers, or attached to one layer. When no voltage is applied, the suspended particles are arranged in random orientations and tend to absorb light, so that the glass panel looks dark (or opaque), blue or, in more recent developments, grey or black colour. When voltage is applied, the suspended particles align and let light pass. SPDs can be dimmed, and allow instant control of the amount of light and heat passing through. A small but constant electrical is required for keeping the SPD smart window in its transparent stage.

In polymer dispersed liquid crystal devices, liquid crystal droplets are arranged in a sheet between two layers of glass. In the “off” state, they are randomly oriented and, when switched on, they align according to the electric field. The liquid crystals scatter light, without blocking it, thus the glass looks white even when in its transparent state. There is a possibility of controlling the amount of light and heat passing through when tints and special inner layers are used. The polymer dispersed liquid crystal device operates in on or off states only.

The existing prior art has not recognized the problem of flash device visibility when protection of the flash device is already sufficient. No techniques have been devised for reducing flash device visibility without increasing flash device protection, or without reducing flash performance. Likewise, no techniques have been devised for reducing flash device visibility without mechanical innovations such as removable covers or pop-up flashes. And none of these unrecognized problems have been addressed by using any smart glass technology.

### SUMMARY OF THE INVENTION

The present invention is a flash window that hides the Flash LED while it is not used. The window is transparent for the light during usage. This can be accomplished using an element with switchable transmissivity, for example smart glass. The element with switchable transmissivity can be placed in front of the flash to hide the flash element.

The flash could be hidden by reducing the transmittance of the flash window, for example by making the flash window milky, or by adding patterns on the flash window. The disadvantage of this is that the reduced transmittance continues also while the flash is on, i.e. flash performance is reduced. In contrast to this, the present invention would enable different levels of transmittance for the status of flash on and flash off.

A method, apparatus, and software are devised for providing an enable signal indicative that an illuminating element of an apparatus will be illuminated. In response to that enable signal, a light transmission property of an electrically switchable material is increased, the electrically switchable material being located at an exterior of the apparatus. Also, the illuminating element is activated, so that it shines through the electrically switchable material, at least after the light transmission property of the electrically switchable material has been increased.

### BRIEF DESCRIPTION OF THE DRAWINGS

FIG. 1 is a flow chart depicting a method according to an embodiment of the present invention.

FIG. 2 is a block diagram depicting a mobile communication device according to an embodiment of the present invention.

### DETAILED DESCRIPTION OF THE INVENTION

An embodiment of the present invention will now be described, merely to illustrate one way of implementing the invention, and without limiting the scope or coverage of what is described elsewhere herein. A person of ordinary skill will understand that there are many other ways of implementing the present claimed invention.

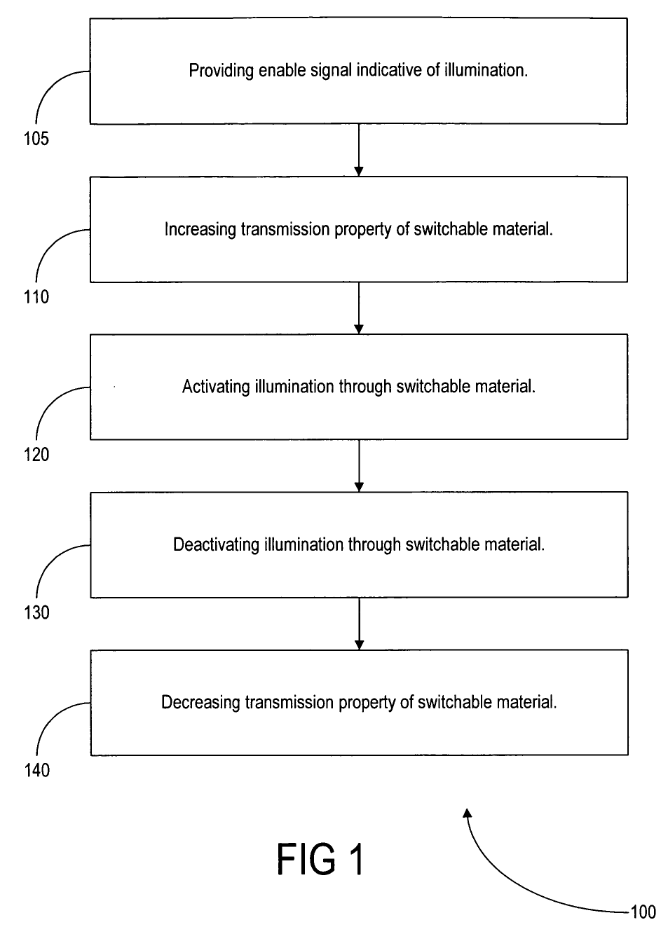

As seen in FIG. 1, a method 100 begins by providing 105 an enable signal indicative of desired illumination. This enable signal may, for example, be initiated by a user touching a user interface of a mobile terminal. In response to the enable signal, a transmission property of a switchable material is increased 110. For example, the switchable material may include a liquid crystal device. Increasing the transmission property of this material causes it to become transparent, at which time illumination is activated 120 through the material. Subsequently, the illumination is deactivated 130, and the transmission property of the switchable material is decreased 140 back to what it was at the beginning of the method.

The source of illumination may be an LED flash. When the flash is not used, the liquid crystal device will be switched to dark (i.e. liquid crystal will block incoming light), and therefore the flash LED will not be visible. When the flash is enabled (e.g. during camera application or when it is used as a flashlight), the switchable element will be switched to transparent so that the light of the flash can pass through the window composed of the switchable material. This is all accomplished by connecting the enable signal for the flash to the signal that switches the liquid crystal device.

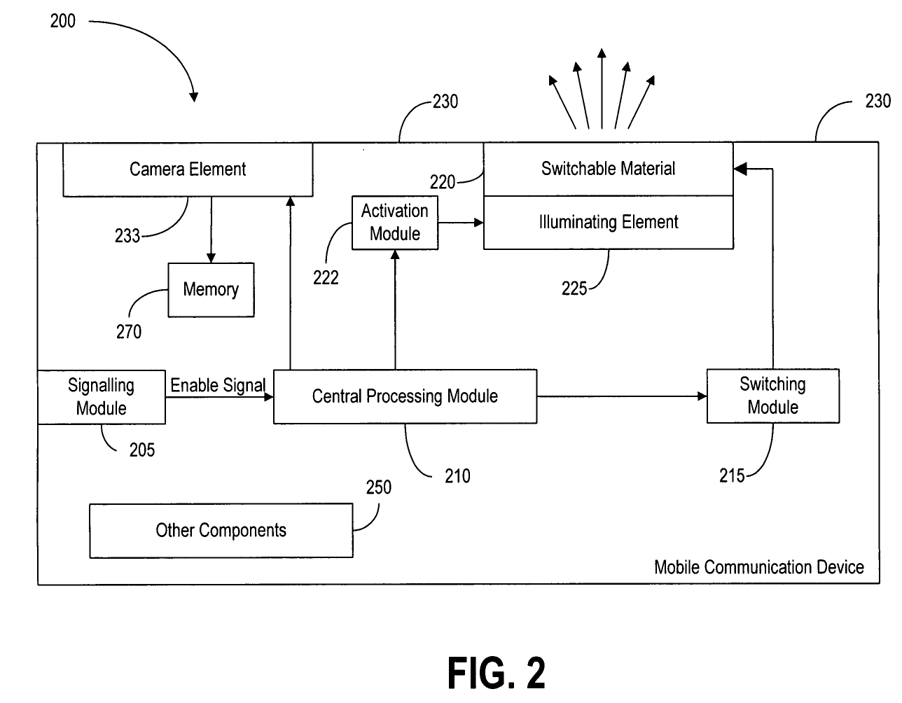

Turning now to FIG. 2, a mobile communication device 200 is shown, according to an embodiment of the present invention. A signaling module 205 provides an enable signal to a central processing module 210. The signaling module may, for example, be providing this signal in response to a use command via a user interface. In any case, the central processing module then commands a switching module 215 to increase a light transmission property of switchable material 220. Also, and activation module 222 is commanded to activate the illuminating element 225, so that the illuminating element 225 will shine through the switchable material 220, at least after the transmission property is increased, thereby illuminating the environment.

With the environment illuminated, the central processing module 210 instructs the camera element (e.g. lens) 233 to capture an image, which can then be stored in the memory 270. Of course, the mobile communication device 200 also includes other components' 250 for wireless communication, in addition to those described above. The arrangement shown in FIG. 2 also includes exterior material 230 adjacent to the switchable material 230. This exterior material 230 preferably looks the same (i.e. has the same color) as the switchable material 220 when the switching module 215 has decreased the light transmission property of the switchable material back to what it was before the enable signal was sent. In this way, the illuminating element will not be visible from outside the mobile communication device, and instead the switchable material will appear to be the same as the exterior material 230. The device thus is able to have illumination capabilities that are not apparent from looking at the device, which allows the user to keep those capabilities confidential or hidden until they are put to use.

The embodiment described above can be implemented using a general purpose or specific-use computer system, with standard operating system software conforming to the method described herein. The software is designed to drive the operation of the particular hardware of the system, and will be compatible with other system components and I/O controllers. The computer system of this embodiment includes the CPU processor 210, comprising a single processing unit, multiple processing units capable of parallel operation, or the CPU can be distributed across one or more processing units in one or more locations, e.g., on a client and server. Memory 270 may comprise any known type of data storage and/or transmission media, including magnetic media, optical media, random access memory (RAM), read-only memory (ROM), a data cache, a data object, etc. Moreover, similar to the CPU, the memory may reside at a single physical location, comprising one or more types of data storage, or be distributed across a plurality of physical systems in various forms.

It is to be understood that the present figures, and the accompanying narrative discussions of best mode embodiments, do not purport to be completely rigorous treatments of the method, system, mobile device, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein. For example, the signalling, switching, and activation modules mentioned herein could be separate entities, or instead could be a single component performing multiple functions.

What is claimed is:

1. An apparatus comprising:
a signalling module configured to provide an enable signal indicative that an illuminating element of said apparatus will be illuminated;
a switching module configured to increase a light transmission property of an electrically switchable material, in response to said enable signal, said electrically switchable material being located at an exterior of the apparatus; and
an activation module configured to activate the illuminating element, so that the illuminating element shines through the electrically switchable material, at least after said increasing of the light transmission property of said electrically switchable material.

2. The apparatus of claim 1, wherein said switching module is also configured to subsequently decrease the light transmission property of the electrically switchable material after said activating of the illuminating element.

3. The apparatus of claim 2, wherein said light transmission property after said decreasing is substantially equal to said light transmission property before said increasing.

4. The apparatus of claim 1, wherein said illuminating element is located between said electrically switchable material and an interior of said apparatus.

5. The apparatus of claim 1,
wherein the apparatus is a mobile communication device that also comprises a digital camera for taking still or motion pictures, and
wherein the illuminating element comprises a light-emitting diode.

6. The apparatus of claim 1, wherein the electrically switchable material comprises a liquid crystal device, an electrochromic device, or a suspended particle device that is substantially transparent after said increasing of the light transmission property.

7. The apparatus of claim 1, wherein before said increasing of the light transmission property, the electrically switchable material is substantially colored like said exterior of said apparatus adjacent to said electrically switchable material.

8. The apparatus of claim 1, wherein said enable signal is responsive to a user activating a photographic capability of the apparatus.

9. The apparatus of claim 2, wherein the activation module is also configured to deactivate the illuminating element after said increasing of the light transmission property.

10. The apparatus of claim 1,
wherein the illuminating element comprises a light-emitting diode, and
wherein before said activating of the illuminating element, and before said increasing of the light transmission property, the illuminating element is not visible through the electrically switchable material.

11. A method comprising:
providing an enable signal indicative that an illuminating element of an apparatus will be illuminated;
increasing a light transmission property of an electrically switchable material, in response to said enable signal, said electrically switchable material being located at an exterior of the apparatus; and
activating the illuminating element, so that the illuminating element shines through the electrically switchable material, at least after said increasing of the light transmission property of said electrically switchable material.

12. The method of claim 11, further comprising decreasing the light transmission property of the electrically switchable material at a time after said activating of the illuminating element, wherein said time is also after said increasing of the light transmission property.

13. The method of claim 12, wherein said light transmission property after said decreasing is substantially equal to said light transmission property before said increasing.

14. The method of claim 11, wherein said illuminating element is located between said electrically switchable material and an interior of said apparatus.

15. The method of claim 11,
wherein the apparatus is a mobile communication device that also comprises a digital camera for taking still or motion pictures, and
wherein the illuminating element comprises a light-emitting diode.

16. The method of claim 11, wherein the electrically switchable material comprises a liquid crystal device, an electrochromic device, or a suspended particle device that is substantially transparent after said increasing of the light transmission property.

17. The method of claim 11, wherein before said increasing of the light transmission property, the electrically switchable material is substantially colored like said exterior of said apparatus adjacent to said electrically switchable material.

18. The method of claim 11, wherein said enable signal is responsive to a user activating a photographic capability of the apparatus.

19. The method of claim 12, further comprising deactivating the illuminating element after said increasing of the light transmission property.

20. The method of claim 11,
wherein the illuminating element comprises a light-emitting diode, and
wherein before said activating of the illuminating element, and before said increasing of the light transmission property, the illuminating element is not visible through the electrically switchable material.

21. A computer program product for use in an apparatus, the computer program product comprising a computer readable medium having executable code stored therein; the code, when executed by a processor, adapted to carry out the functions of:
providing an enable signal indicative that an illuminating element of an apparatus will be illuminated;
increasing a light transmission property of an electrically switchable material, in response to said enable signal, said electrically switchable material being located at an exterior of the apparatus; and
activating the illuminating element, so that the illuminating element shines through the electrically switchable material, at least after said increasing of the light transmission property of said electrically switchable material.

22. The computer program product of claim 21, further comprising decreasing the light transmission property of the electrically switchable material at a time after said activating of the illuminating element, wherein said time is also after said increasing of the light transmission property.

23. The computer program product of claim 22, wherein said light transmission property after said decreasing is substantially equal to said light transmission property before said increasing.

24. The computer program product of claim 21, wherein said illuminating element is located between said electrically switchable material and an interior of said apparatus.

25. The computer program product of claim 21,
wherein the apparatus is a mobile communication device that also comprises a digital camera for taking still or motion pictures, and
wherein the illuminating element comprises a light-emitting diode.

26. The computer program product of claim 21, wherein the electrically switchable material comprises a liquid crystal device, an electrochromic device, or a suspended particle device that is substantially transparent after said increasing of the light transmission property.

27. The computer program product of claim 21, wherein before said increasing of the light transmission property, the electrically switchable material is substantially colored like said exterior of said apparatus adjacent to said electrically switchable material.

28. The computer program product of claim 21, wherein said enable signal is responsive to a user activating a photographic capability of the apparatus.

29. The computer program product of claim 22, further comprising deactivating the illuminating element after said increasing of the light transmission property.

30. The computer program product of claim 21,
wherein the illuminating element comprises a light-emitting diode, and
wherein before said activating of the illuminating element, and before said increasing of the light transmission property, the illuminating element is not visible through the electrically switchable material.

31. An apparatus comprising:
means for providing an enable signal indicative that an illuminating element of said apparatus will be illuminated;
means for increasing a light transmission property of an electrically switchable material, in response to said enable signal, said electrically switchable material being located at an exterior of the apparatus; and
means for activating the illuminating element, so that the illuminating element shines through the electrically switchable material, at least after said increasing of the light transmission property of said electrically switchable material.

32. The apparatus of claim 31, wherein said means for increasing is also for subsequently decreasing the light transmission property of the electrically switchable material after said activating of the illuminating element.

33. The apparatus of claim 32, wherein said light transmission property after said decreasing is substantially equal to said light transmission property before said increasing.

34. The apparatus of claim 31, wherein said illuminating element is located between said electrically switchable material and an interior of said apparatus.

35. The apparatus of claim 31,
wherein the apparatus is a mobile communication device that also comprises a digital camera for taking still or motion pictures, and
wherein the illuminating element comprises a light-emitting diode.
